(19) United States
(12) Patent Application Publication
(10) Pub. No.: US 2008/0162856 A1
(43) Pub. Date: Jul. 3, 2008

(54) METHOD FOR DYNAMIC MEMORY ALLOCATION ON RECONFIGURABLE LOGIC

(75) Inventors: Sek M. Chai, Streamwood, IL (US); Joon Young Park, Libertyville, IL (US)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/618,326

(22) Filed: Dec. 29, 2006

(51) Int. Cl. G06F 12/02

(52) U.S. Cl. 711/170

(57) ABSTRACT

A method, apparatus, and electronic device for improving memory performance are disclosed. The method may include automatically checking reconfigurable logic for available memory and executing a first memory allocation to the available memory.

### 1. FIELD OF THE INVENTION

The present invention relates to a method and system for increasing memory access speed and efficiency. The present invention further relates to using unallocated memory on reconfigurable logic to improve memory performance.

### 2. INTRODUCTION

In designing a software program, a given block of memory may be allocated to store each object that is created dynamically during runtime. The size of the block may be specified in bits or bytes while leaving the value for the object unspecified. The block of memory may be made of multiple sets of bits that need not necessarily be contiguous or grouped in any specific order. The allocation may be performed by a “malloc” function that returns a pointer or series of pointers to the location of the assigned memory. The assigned pointer then returns the object stored there until such time as the memory is freed or reallocated. If the required size is greater than the available memory, a null pointer may be returned by the malloc function.

Memory allocation functions may be used to allocate memory from a number of types of memory, such as dynamic random access memory (DRAM). Allocating memory during runtime from the external DRAM has a high latency penalty.

### SUMMARY OF THE INVENTION

A method, apparatus, and electronic device for improving memory performance are disclosed. The method may include checking reconfigurable logic for available memory and automatically executing a first memory allocation to the available memory.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a possible configuration of a computer system to use the memory system of the present invention.

FIGS. 2a-b illustrates one embodiment of a method for establishing memory allocation availability.

FIG. 3 illustrates one embodiment of a memory allocation technique that may be applied to the reconfigurable logic memory referred to as binary buddy block.

FIG. 4 illustrates one embodiment of a method for dynamic memory allocation using buddy block.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and an electronic device, and other embodiments that relate to the basic concepts of the invention. The electronic device may be any manner of computational device.

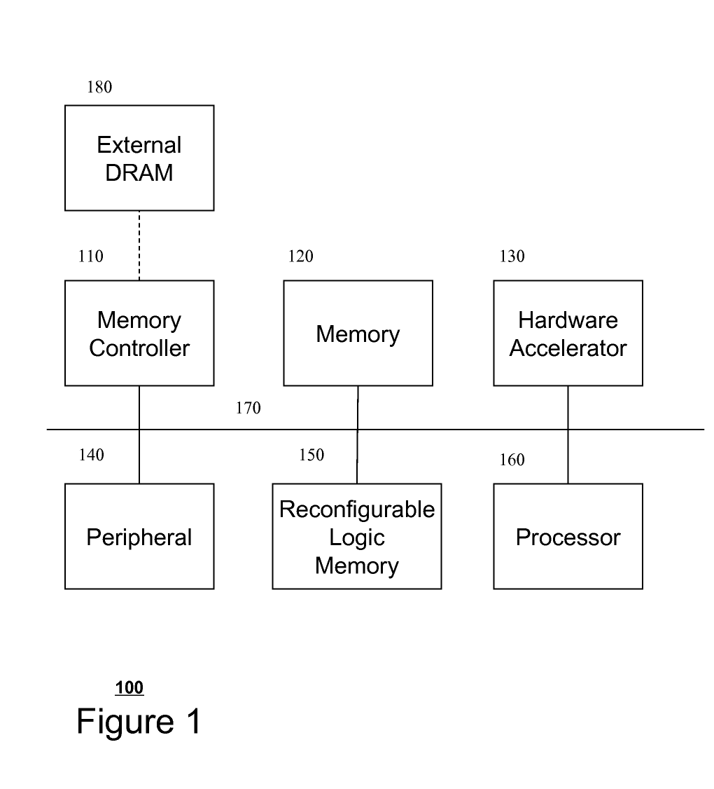

A method, apparatus, and electronic device for improving memory performance are disclosed. FIG. 1 illustrates a possible configuration of a computer system 100 to act as a mobile system or base station to execute the present invention. The computer system 100 may include a memory controller 110, a memory 120, a hardware accelerator 130, peripherals 140, a reconfigurable logic memory 150, and a processor 160 connected through a bus 170. The memory controller 110 may access an external dynamic random access memory (DRAM) 180. In an alternative embodiment, the computer system 100 is implemented in a system-on-chip (SoC), wherein the reconfigurable logic is embedded with components of the computer system 100. It is known in the art that elements on the computer system 100 can be implemented in reconfigurable logic.

When allocating memory, the memory controller 110 may allocate available memory from the reconfigurable logic memory 150 before allocating memory from the external DRAM 180. Memory access and bandwidth in a reconfigurable logic memory 150 can be higher than external DRAM 180. Furthermore, memory fragmentation, especially from small memory objects, can be reduced using reconfigurable logic memory.

The memory controller 110 may be any programmed processor known to one of skill in the art. However, the memory support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The memory 120 may include volatile and nonvolatile data storage, including one or more electrical, magnetic or optical memories such as a random access memory (RAM), cache, hard drive, compact disc read-only memory (CD-ROM) drive, tape drive or removable storage disk. In an alternative embodiment in an SoC, the memory 120 consists of an interface peripheral to transfer data from external devices.

The hardware accelerator 130 may accelerate a function normally performed by the general processor 160, such as the central processing unit (CPU) or the memory controller 110, by performing the function in a separate dedicated device. These functions may include any function normally performed by a general processing device. One such use of a hardware accelerator 130 is by using a parallel memory search when determining available memory to be allocated.

The peripherals 140 may be any peripheral hardware device that may be attached to the computational device 100. These may include any removable or internal storage device (such as compact disc reader, digital versatile disc reader, a universal serial bus (USB) flash drive, a disk storage array, or others), any manual or automatic input devices (such as keyboard, mouse, joystick, image scanner, webcam, barcode readers, or others), output devices (such as printers, speakers, monitors, or others), networking devices (modems, network cards, or others), expansion devices, or other devices. The above list is exemplary and not exhaustive.

The reconfigurable logic 150 is incorporated in a system on a chip to increase the density of these chips. One common type of reconfigurable logic is field programmable gate array (FPGA). An FPGA is a semiconductor device containing programmable logic components that may duplicate the functionality of various logic gates and other hardware devices. These devices often include memory components that may be exploited in the present invention. The reconfigurable logic memory 150 may include SRAMs, a set of valid bits, and comparators for each memory block. The SRAMs may be block SRAMs or distributed SRAMs. Other logic units, such as the lookup tables (LUT) and configuration memory (e.g. memory to store hardware configuration), may also be used for memory allocation. The reconfigurable logic memory 150 may be instantiated as a memory mapped unit in a processor or in a memory controller. The reconfigurable logic memory 150 may be allocated part of the memory map for memory. The bus address decoder is unique based on configuration of the reconfigurable logic memory 150.

The processor 160 may be any standard processor as commonly known in the art.

The external DRAM 180 may store data in a non-permanent format. DRAM allows for quicker access of data than a more permanent format memory 120. Therefore, during runtime, the DRAM 180 is the working memory, with data stored to the DRAM being written to a permanent memory 120 and data to be processed read from the memory 120 to the DRAM 180. However, the external nature of the DRAM 180 makes the DRAM less readily accessible than the reconfigurable logic memory 150.

Client software and databases may be accessed by the controller/processor 110 from memory 120, and may include, for example, database applications, word processing applications, the client side of a client/server application such as a billing system, as well as components that embody the decision support functionality of the present invention. The computer system 100 may implement any operating system, such as Windows or UNIX, for example. Client and server software may be written in any programming language, such as ABAP, C, C++, Java or Visual Basic, for example.

Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

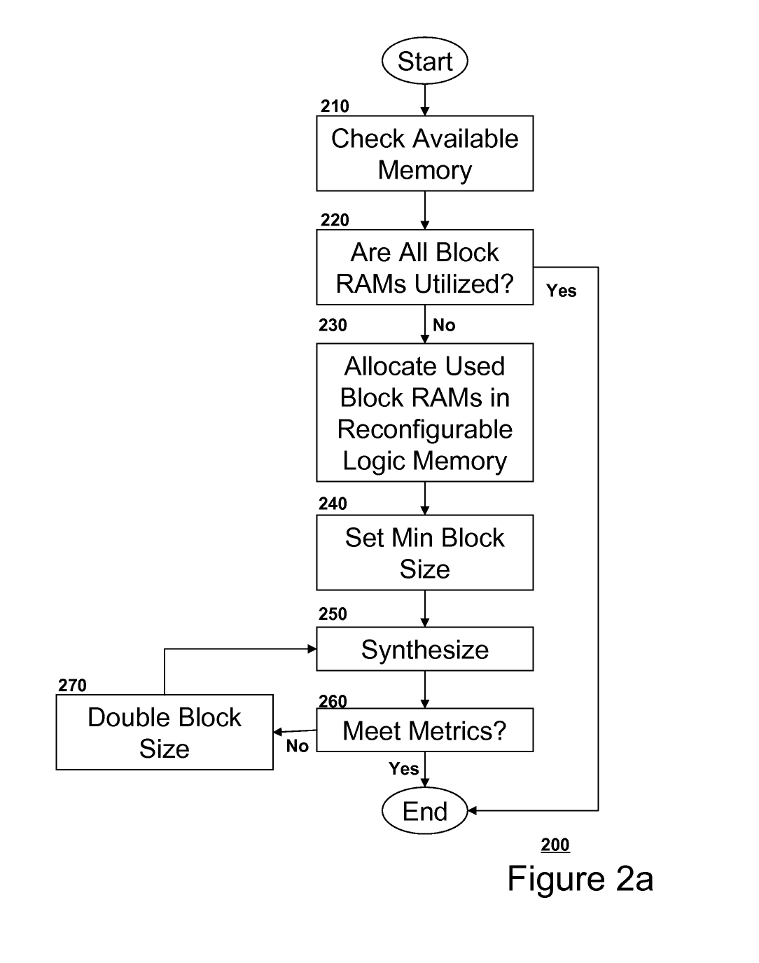

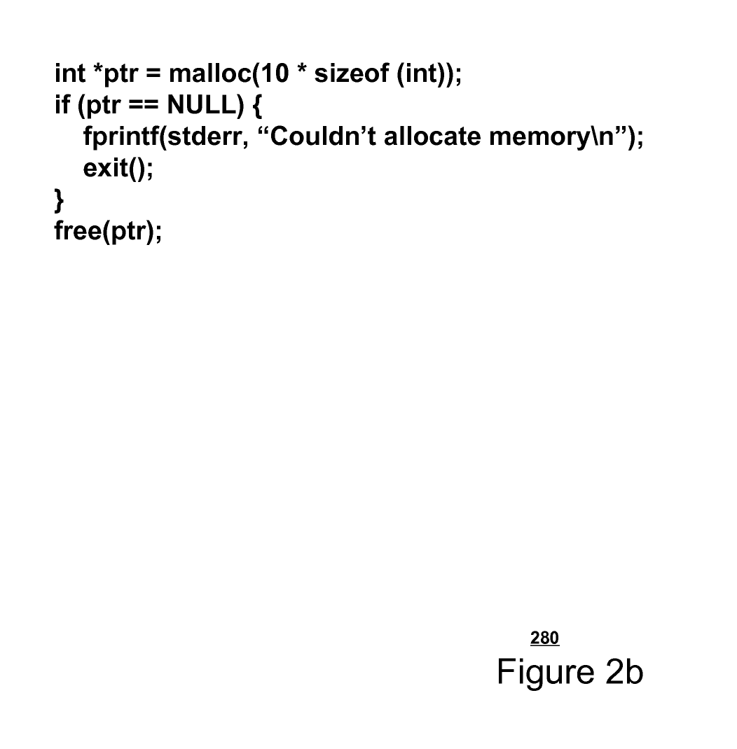

FIGS. 2a-b illustrate one embodiment of a method 200 for establishing memory allocation availability. FIG. 2a illustrates in a flowchart one embodiment of the method 200. The memory controller 110 checks available memory in the reconfigurable logic (Block 210). Checking available memory may include updating at least one of a table or a list of available memories in the reconfigurable logic. If all the block RAMs are utilized (Block 220), no further action is taken regarding reconfigurable logic. If some block RAMs are not utilized (Block 220), the memory controller 110 allocates unused block RAMs in reconfigurable logic 150 (Block 230). Such an allocation may include updating at least one of a table or a list of available memories in the reconfigurable logic. The memory controller 110 sets the minimum block size (Block 240). The memory controller 110 synthesizes the memory blocks in reconfigurable logic (Block 250). If the memory blocks meet the metrics (Block 260), no further action need be done. These metrics may include memory access speed, bandwidth, efficiency, memory retention, power consumption, or other performance metrics. If the memory blocks do not meet the metrics (Block 260), the memory controller 110 adjusts the block size, for example by doubling it (Block 270). While the memory controller 110 is cited in the above example, the processor 160, a peripheral 140, the reconfigurable logic memory 150, or other devices may also perform the memory allocation function in the reconfigurable logic memory 150.

The method 200 may be implemented in a compiler for high level programming languages, such as ABAP, C, C++, Java or Visual Basic. FIG. 2b illustrates one embodiment of a block of C++ code 280 that executes the memory allocation and freeing operation. The method 200 may be implemented either during application compile time or during application run-time. In one embodiment, the method 200 may be implemented in a synthesis tool to generate circuits for reconfigurable logic. In yet another embodiment, the method 200 may be implemented in an operating system or application code. In these embodiments, the memory circuit in the reconfigurable logic is generated automatically without designer intervention. In an embodiment wherein portions of the reconfigurable logic are used to implement the computer system 100, such as the hardware accelerator 130, available SRAM modules in the reconfigurable logic may be used for the memory allocation method 200.

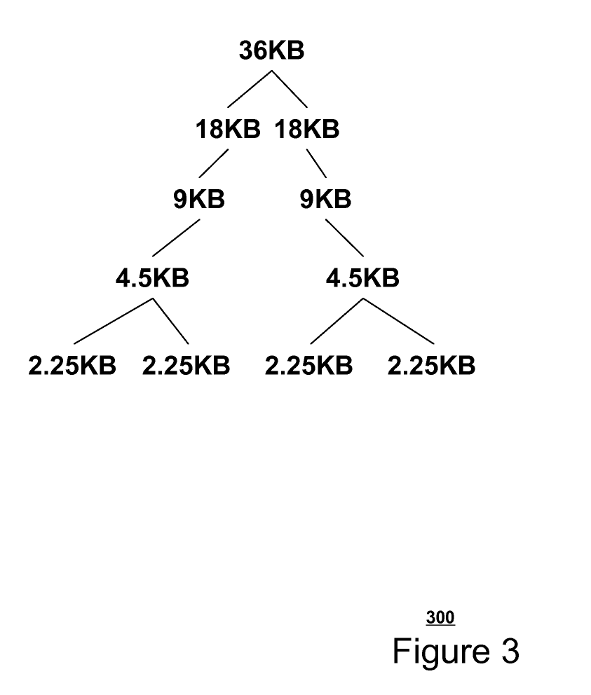

FIG. 3 illustrates one embodiment of a memory allocation technique that may be applied to the reconfigurable logic memory 150 referred to as binary buddy block 300. A block is partitioned into two, with each sub-block further partitioned into two until the block is of the approximate size needed for use by the system. As a pair of sub-blocks is freed, those sub-blocks are recombined into a new block. Alternately, the memory controller 110 may use a free list or a linked list to allocate the reconfigurable logic 150. A memory controller 110 adds a block of unused memory to a free list, removing the block from the list when that block is allocated. In a linked list, the beginning of the listing for an unallocated block points to the next unallocated block. One variant of the linked list is a double linked list, where the listing for the unallocated block points to both the previous and next block. In another alternative embodiment, the memory controller 110 may use a heap-based memory allocation system. In a heap-based memory allocation system, memory is allocated from a set of unused memory referred to as a heap. The memory controller 110 may access a region of the heap via a reference. Other memory allocation techniques may be used as well. The binary buddy block allocation technique 300 maps well to reconfigurable logic 150 because the SRAM modules in FPGA are small and distributed. Different size memory generated by configuring the SRAM modules and associated logic in the reconfigurable logic 150.

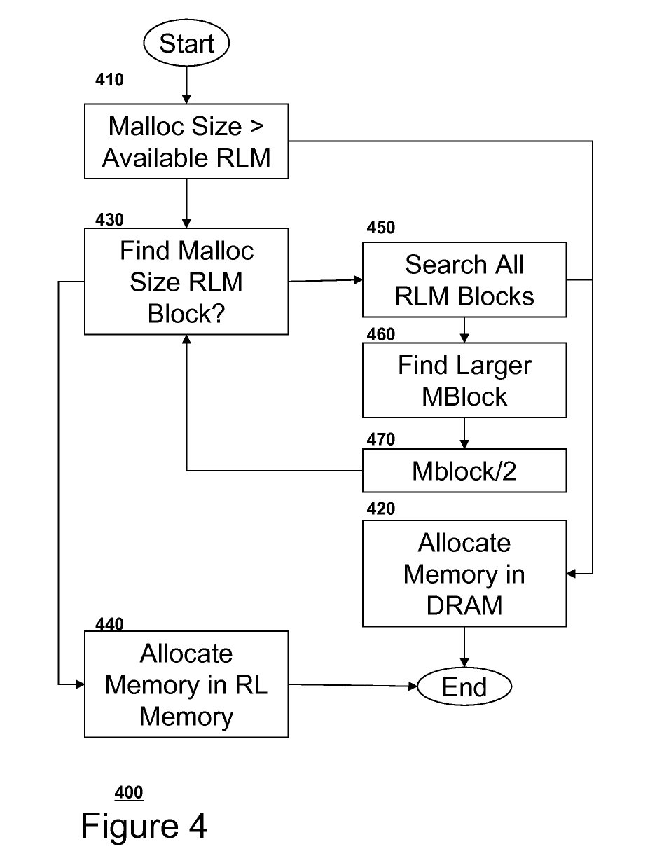

FIG. 4 illustrates one embodiment of a method 400 for dynamic memory allocation using buddy block. If the memory allocation size is bigger than the available reconfigurable logic memory (RLM) (Block 410), the memory controller 110 may allocate memory in DRAM 180 (Block 420). If the memory allocation size is not bigger than the available reconfigurable logic (Block 410) and if a reconfigurable logic memory block of the appropriate size is available (Block 430), the memory controller 110 may allocate memory in reconfigurable logic 150 (Block 440). If a reconfigurable logic memory block of the appropriate size is available (Block 430) and all the reconfigurable logic blocks (RLM Blocks) have been searched (Block 450), the memory controller 110 may find a larger memory block (MBlock) (Block 460) and partition it in two (Block 470). The method 400 may be implemented in the computer systems such as the processor (160), hardware accelerator 130, memory controller 110, or reconfigurable logic memory 150. In yet another embodiment, the method 400 may be implemented in an operating system or application code. In these embodiments, the memory circuit in the reconfigurable logic memory 150 is either generated automatically prior to application run-time during software program compilation or hardware synthesis. Alternatively, the memory circuit in the reconfigurable logic memory 150 can be dynamically generated during application run-time.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. It does not necessarily need to be one system used by all end users. Accordingly, the appended claims and their legal equivalents should only define the invention, rather than any specific examples given.

We claim:

1. A method for improving memory performance, comprising:
checking a reconfigurable logic circuit for available memory;
generating a memory circuit from the available memory; and
automatically executing a first memory allocation to the memory circuit.

2. The method of claim 1, further comprising executing a second memory allocation to a dynamic random access memory only if no memory is available in the reconfigurable logic circuit.

3. The method of claim 1, wherein the memory circuit includes at least one of reconfigurable logic memory selected from a group consisting of block static random access memory, distributed static random access memory, look-up table memories, and configuration memory.

4. The method of claim 1, further comprising adjusting allocated memory block size based on at least one performance metric selected from a group consisting of memory access speed, bandwidth, efficiency, memory retention, and power consumption.

5. The method of claim 1, further comprising using at least one memory algorithm selected from a group consisting of buddy block, linked list, double link list, or heap-based memory allocation as a memory allocation algorithm.

6. The method of claim 1, further comprising wherein the memory circuit is generated from the reconfigurable logic circuit during software compilation.

7. A system on a chip with improved memory performance, comprising:
a reconfigurable logic circuit; and
a processor that checks the reconfigurable logic circuit for available memory and automatically executes a first memory allocation to the available memory.

8. The system on a chip of claim 7, wherein the processor executes a second memory allocation to a dynamic random access memory only if no memory is available in the reconfigurable logic circuit.

9. The system on a chip of claim 7, wherein the available memory includes at least one of reconfigurable logic memory selected from a group consisting of block static random access memory, distributed static random access memory, look-up table memories, and configuration memory.

10. The system on a chip of claim 7, wherein allocated memory block size is adjusted based on at least one performance metric selected from a group consisting of memory access speed, bandwidth, efficiency, memory retention, and power consumption.

11. The system on a chip of claim 7, wherein the processor uses at least one memory algorithm selected from a group consisting of buddy block, linked list, double link list, or heap-based memory allocation as a memory allocation algorithm.

12. The system on a chip of claim 7, further comprising a hardware accelerator that executes a parallel memory search determines reconfigurable logic memory availability.

13. The system on a chip of claim 7, further comprising a memory circuit generated from the reconfigurable logic circuit during software compilation.

14. An electronic device with improved memory performance, comprising:
a reconfigurable logic circuit; and
a processor that checks the reconfigurable logic circuit for available memory and automatically executes a first memory allocation to the available memory.

15. The electronic device of claim 13, wherein the processor executes a second memory allocation to a dynamic random access memory only if no memory is available in the reconfigurable logic circuit.

16. The electronic device of claim 13, wherein the available memory includes at least one of reconfigurable logic memory selected from a group consisting of block static random access memory, distributed static random access memory, look-up table memories, and configuration memory.

17. The electronic device of claim 13, wherein allocated memory block size is adjusted based on at least one performance metric selected from a group consisting of memory access speed, bandwidth, efficiency, memory retention, and power consumption.

18. The electronic device of claim 13, wherein the processor uses at least one memory algorithm selected from a group consisting of buddy block, linked list, double link list, or heap-based memory allocation as a memory allocation algorithm.

19. The electronic device of claim 13, further comprising a hardware accelerator that executes a parallel memory search determines reconfigurable logic memory availability.

20. The electronic device of claim 13, further comprising a memory circuit generated from the reconfigurable logic circuit during software compilation.
